(19) United States
(12) Patent Application Publication
(10) Pub. No.: US 2017/0134320 A1
(43) Pub. Date: May 11, 2017

(54) Method and System for Compositing Asynchronous Video Messages and Responses

(71) Applicant: Kwickie International Ltd, Phillip (AU)

(72) Inventors: Arienne Sellers, Robina (AU); Jacob Gough, Robina (AU); George Fidler, Robina (AU); Dan Ross, Robina (AU); Darran Franks, Robina (AU); Paul deLange, Robina (AU); Arash Daneshvar, Robina (AU); Josh Lapham, Robina (AU); William Rapert, Robina (AU); Mike Bobrov, Robina (AU); Grady Vincent, Robina (AU)

(21) Appl. No.: 14/964,061

(22) Filed: Dec. 9, 2015

(30) Foreign Application Priority Data
Nov. 10, 2015 (AU) 2015904623

(51) Int. Cl. H04L 12/58

(52) U.S. Cl. CPC H04L 51/10

(57) ABSTRACT

A method and system for the recording of separate asynchronous video conversations and compositing them into one video, which simulates a real-time, synchronous conversation is provided and particularly a method and system used to allow a fan to interact with an influencer.

This application claims priority to Australian Patent Application No. 2015904623 filed on Nov. 10, 2015, the entire contents of which are incorporated herein by reference.

The present invention relates generally to the field of video messaging and particularly to emulating a synchronous fan video message and second person video reply, by compositing an asynchronous video messages and response.

### BACKGROUND

Creating a service which facilitates synchronous “real time” interaction between influencers and their fans is logistically difficult and fraught with risks. Even something which, on the surface, seems relatively simple such as getting both parties on-line and connected in real time, is usually not possible.

It will be clearly understood that, if a prior art publication is referred to herein, this reference does not constitute an admission that the publication forms part of the common general knowledge in the art in Australia or in any other country.

### SUMMARY

The present invention is directed to a method and system for compositing asynchronous video messages and responses, which may at least partially overcome at least one of the above-mentioned disadvantages or provide the consumer with a useful or commercial choice.

With the foregoing in view, the present invention in one form, resides broadly in a method of compositing asynchronous video messages and responses including the steps of:
a. a first person creating an electronic first person message having an audio component and a visual component;
b. forwarding the first person message to a second person over an electronic data transmission network;
c. the second person initiating playback of the first person message at a time convenient to the second person;
d. capturing a second person reaction recording in real time based on initiating the playback of the first person message;
e. the second person creating a second person response message having an audio component and a visual component in response to the first person message;
f. compositing the first person message, the second person reaction recording and the second person response into a composite recording; and
g. delivering the composite recording to at least the first person via an electronic data transmission network.

In an alternative aspect, the present invention resides in a system for compositing asynchronous video messages and responses, the system including:
a. at least one computer server or computer network operating a primary software application;
b. at least one first person with a personal computing device having an audio capture device, a video capture device and data transmission capability and operating a secondary software application to create an electronic first person message having an audio component and a video component;
c. the at least one first person forwarding the first person message to a second person over an electronic data transmission network accessible through at least the secondary software application operating on the at least one first person's personal computing device;
d. at least one second person with a personal computing device having an audio display and capture device, a video display and capture device and data transmission capability and operating a secondary software application to allow the at least one second person to initiate playback of the first person message on the second person's personal computing device at a time convenient to the second person;
e. capturing a second person reaction recording in real time via the secondary software application, audio display and capture device and video display and capture device of the second person's personal computing device, based on initiating the playback of the first person message;
f. the second person creating an second person response message having an audio component and a visual component in response to the first person message using the secondary software application, the audio display and capture device and video display and capture device of the second person's personal computing device;
g. transmitting the electronic first person message, the second person reaction recording and the second person response message to the primary software application operating on the at least one computer server or computer network;
h. the primary software application operating on the at least one computer server or computer network compositing the first person message, the second person reaction recording and the second person response into a composite recording; and
i. delivering the composite recording to at least the first person via an electronic data transmission network.

The present invention provides a method and system for the recording of separate asynchronous video messages and compositing them into one video, which simulates a real-time, synchronous conversation. In a most preferred embodiment, the method and system of the present invention will be used to allow a fan to interact with an influencer. The influencer can be a sports star or personality, an entertainment personality or any type of person with an image that may appeal to a fan.

The method and system of the present invention is based about a first person utilizing a personal computing device such as a smartphone, computer, tablet computer or any other personal computing device to capture an audio/video message and then send that audio/video message to a second person who also has a personal computing device such as a smartphone, computer, tablet computer or any other personal computing device for playback, record the second person's reaction to the first person's audio/video message, allow the second person to record an audio/video message in response thereto and then composite the messages and reaction into a single audio/video message.

Preferably, access to the system for both the first person and the second person will be via the personal computing device. The secondary software application may be the same application and the functionality and use of the software application determined by the category of the user which is preferably determined at login according to the user's unique login information. As mentioned above, the personal computing device can be any type however, it will typically be a smart phone, computer tablet or other portable device having at least one communication pathway in order to communicate with the computer server or computer network operating a primary software application.

The personal computing device preferred for use in the present invention includes a processor with on-board memory, a display, at least one input apparatus, at least one output apparatus (such as audio output, directly via speakers or similar or indirectly via a port or similar allowing the connection of speakers, visual output or similar), and access to at least one communication pathway to transmit data between system components. Normally, the display will preferably be a touchscreen as many personal computing devices currently available have this feature. The advantages of the touchscreen include allowing a larger display and also allowing the display to function as a part of or as, the input apparatus. The display will also function as a video playback device. These types of devices also usually have at least one camera and at least one microphone which will allow video capture and audio capture.

Preferably, the software operating on the hardware of the system of the present invention includes a primary software application operating on the computer server or computer network. Preferably, a secondary software component is provided at the personal computing device level on each of the user personal computing devices in order to interact with the primary software application.

The primary software application is preferably the “engine” of the system and method, responsible for receiving the various messages and recordings created or captured by a user (fan and/or influencer) and to composite these into a single message for delivery to a user.

The system for compositing asynchronous video messages and responses of the present invention preferably includes a secondary software application designed to operate on smartphones, tablet computers and another mobile device that each customer and consumer will require in order to access the Internet data transmission. The software application will preferably be available through an application distribution platform, which is typically operated by the owner of the mobile operating system, such as the Apple App Store, Google Play, Windows Phone Store and BlackBerry App World. The application of the present invention will normally be downloaded from the application distribution platform to a target mobile device.

Preferably, the secondary software application is provided to operate on a personal computing device with appropriate connections through the personal computing device to the computer server or computer network operating a primary software application in order to gain additional information to that present on the personal computing device. The additional information may be obtained from the computer server or computer network and/or by push notification from the computer server or computer network to the personal computing device and/or upon request from the personal computing device.

The secondary software application will preferably allow communication with the primary software application operating on the computer server or computer network. Preferably, the primary software program operating on the computer server or computer network will be more advanced and be responsible for the bulk of the processing with the secondary software application operating on the smartphones, tablet computers and another mobile device typically smaller and with less processing power, optimized to send and receive instructions and requests and leaves the operations requiring larger processing power to the primary software program operating on the computer server or computer network.

According to a preferred embodiment, the present invention will preferably have a number of parties associated with the system, with a party categorized into one or more general types. The preferred types of parties associated with the system include a system administrator (which can be one or more people, and/or machines in one or more locations), fans who ask questions and create messages and influencers who are people with which the fans wish to interact and/or be associated.

Users will normally download the software application to their personal computing device. The download of the software application will normally include appropriate instructions to be stored in the memory of the personal computing device in order to create and maintain links and associations with the computer server or computer network in order to communicate with one or more databases stored thereon.

The personal computing device normally provides access to one or more communications pathways in order to communicate with the computer server or computer network in order to access the system. Normally, the computer server or computer network will include one or more databases containing information about the users such that information regarding the identity of any one or more of these parties may be communicated by the personal computing device or the software application to ensure that the personal computing device requesting data from the computer server or computer network or to which data is to be sent or from which information is received, is a personal computing device of an authorized user of the system. This functionality is normally accomplished through a login facility in which the user uses a personal computing device to log into the system.

The login process may use login details that the user has developed for another application or use. For example, the user may use a Facebook or Twitter account login or similar or alternatively login details for an email system such as Gmail or Hotmail in order to access the system of the present invention. Normally, details of the user login will be stored in a corresponding user profile in at least one user database and as a login request is received, the computer server or computer network will typically ensure that the login details supplied match those of a user before allowing access to the system and any databases on the system.

Normally, a login prompt is produced and displayed as a displayed image or interface on the display of the personal computing device and including at least one action button. This will normally allow input or selection of the desired login information into an input template and which also prompts input of the login information provided by action in the form of a submission to the computer server or computer network. This will normally be a two-part process in which the user will normally select the desired login type if permitted followed by entry of the user particular identification information and password followed by the submission step. Upon submission, the entered details will be sent to the primary software application operating on the computer server or computer network for authorization.

Therefore, the personal computing device is typically used to create a login request which is then sent via a communications pathway to the computer server or computer network whereupon the system of the present invention checks the user database(s) for a match and allows access to the system if the match occurs and denies access to the system if a match does not occur.

The at least one input apparatus used to input information into the personal computing device therefore will typically be formed or displayed on the display of the personal computing device as required. The at least one input apparatus will normally take the form of a virtual keyboard including letters of the alphabet, numbers and/or symbols as well as one or more action icons to allow a user to implement action on the personal computing device.

Typically, a portion of the image displayed on the display of the personal computing device will be provided as visual feedback reflecting the input provided by the user of the personal computing device.

Other types of input apparatus are typically also present including at least one voice input apparatus, typically a microphone or similar device or a biometric device could be used.

The method of the present invention is preferably achieved by computer hardware operating software containing instructions in association with one or more communications pathways between a variety of pieces of computer hardware operating software compliant with the system, in order to achieve the method.

The computer hardware included in the system of the present invention typically includes a computer server or computer network operating the primary software application which is operated or maintained by a system administrator and which electronically stores information in relation to the users of the system and also receives data, forms the composite messages and dispatched the composite messages. The hardware also preferably includes or has access to a communication network in order to send/receive requests from users to and from the computer server or computer network.

As mentioned above, the hardware included in the system of the present invention also includes a personal computing device for each user. The respective personal computing devices will preferably be the primary points of access to the system of the present invention by the users of the system and normally interaction with the primary software application operating on the computer server or computer network will occur using the personal computing devices.

The hardware included in the system of the present invention can be relatively generic hardware including as it does, a computer server and one or more personal computing devices, each with access to a communication network. As mentioned above, the personal computing devices will typically be a smart phone, tablet or other computer.

The computer server or computer network will normally include a processor with memory operating instructions and a number of databases stored in electronic form. The databases will typically include at least one user database containing a unique user profile for each user of the system and at least one database of messages and/or recordings may be maintained separately from the at least one user database or alternatively, the messages and/or recordings may be stored in the respective user profiles. It is anticipated that the at least one user database can be provided as a single database, with the designation of a user as being either a fan or influencer (or both) dependent upon the use of the system.

The system of the present invention will normally be implemented through instructions which when followed, generate one or more interfaces on a personal computing device. The instructions will normally be sent from the primary software application on the computer server or computer network to a user's personal computing device and which will then be followed in order to generate an interface in real time and update the interface according to the user's interaction with the system.

Many of these personal computing devices have touchscreens for display allowing the user to directly interact with the touch screen in order to interact with the interface. However, a normal non-touchscreen display can be used with a movable pointer or selection tool in order to allow a user to interact with the interface. One or more “buttons” are provided on the interface to allow the user to interact with the personal computing device and through the personal computing device, to interact with the system.

The generated interface will typically be updated substantially in real time according to the rules or instructions which are issued by the primary software application operating on the computer server or computer network and the at least one user database. The generated interface will also typically be updated substantially in real time according to interactions by the user(s) with the system.

Typically, the generated interface will be used to login to the system using unique login information or details. Normally this will be the case regardless of what type of user is logging into the system. The classification of the user as a fan or influencer may be made according to the login details or by the user, after login. The system will preferably allow a user to set up a profile designating themselves as a fan, influencer or both and this setup (or any change thereto) is preferably subject to approval by the system administrator.

As mentioned above, a user may login to a third-party system such as a social media network and then access the system of the present invention by interacting or selecting a link which may be displayed on the social media network site. For example, one particularly preferred mechanism for entry to the system of the present invention is through Facebook and particularly, through a link or share which appears on a user's newsfeed. The link will typically be associated with explanatory text or material which explains the concept of the system and because the user is interested, the user will normally, having already logged into Facebook, simply select the link and be redirected to the generated interface of the system of the present invention.

Upon logging by a user, the system of the present invention will preferably generate and display an interface on the personal computer device according to the user category as either a fan or an influencer. A user who is a member of both categories may be prompted to choose their next action.

As a fan using the system, the fan will typically open the secondary software application operating on their personal computing device by tapping the application icon or tile. The first time a fan uses the application, the fan will normally be presented with a signup interface generated and displayed on the display of the personal computing device. The signup interface will prompt the creation of a fan profile including entry of salient information such as the fan's name, email address, preferred password and a picture or image to be used as the profile image.

The fan profile may include other information such as gender, date of birth, address, preferences and/or interests although this information is optional and may be landed added at a later time into the fan profile. The fan profile is preferably stored in a user profile in association with the primary software application operating on the computer server or computer network. The system administrator may undertake a vetting process when a fan creates a new profile or updates their profile to ensure that the information added into the profile is not scandalous or contrary to law in any way and/or that the information added complies with the information required by the system.

Entry of information into the secondary software application is preferably using a virtual keyboard which is produced and displayed on the interface, normally as an overlay and/or uploaded using the personal computing device, particularly, using the image capture software present on the personal computing device and/or the audio capture software. The information will normally be entered into one or more entry fields provided on the interface and there will normally be one or more action buttons on the interface to allow entry of information and/or movement about the interface.

Once the fan has set up their user profile, there will normally be an action button allowing them to continue. The fan can manually activate the “continue” action button and activation of this button will normally trigger generation and display of a further interface.

The further interface generated and displayed will typically depend upon whether this is the fan's first use or a later use. If it is the fan's first use the fan may be prompted to indicate one or more influencers that the fan would like to follow. This is preferably performed through the generation and display of an interface allowing a fan to select one or more influencers. This can be done in any way. For example, the system may have a search facility allowing a fan to search for an influencer's name such as by entry of text, by category, by sporting team or using any other parameter that could be used to identify and characterize an influencer. There may be the ability to provide an influencer leaderboard of most popular influencers and/or suggested influencers based on preferences entered by the fan.

The selection interface will preferably allow a fan to drill down into different areas in order to identify particular influencers. Once the fan has identified one or more influencers to follow, the fan can then preferably “follow” the influencer by tapping an action button which will trigger the addition of that influencer to the fan's profile. Normally, after the setup stage, every time the fan logs into the system, the fan can select from a stored list of influencers that they are following in order to undertake further action.

Selection of a particular influencer will typically trigger generation and display of an influencer profile interface. The influencer profile will typically be constructed in a manner similar to the fan profile and once created, the fan can view the influencer profile by selection of the influencer from a list. The influencer profile will typically include an image of the influencer, together with information relating to the influencer such as demographic information or statistics and the profile will particularly preferably include a newsfeed or update list of current or historical news in relation to the particular influencer.

The fan will also preferably have an action button provided on either the influencer profile interface or directly from the influencer selection interface that will allow the fan to create a fan message. Typically, the action button will allow the fan to begin recording a fan message. The action button will typically be known as a shutter button in some preferred embodiments. Other setup buttons may be provided on the interface or on a subsequent interface allowing the fan to set up the recording. The fan will typically be able to record video or one or more still images together with audio and also be provided with a flip camera button to activate either the front or rear camera on the personal computing device as required.

Activation of the shutter button by the fan will typically cause the secondary software application operating on the personal computing device to begin recording audio and preferably video via the hardware provided on the personal computing device in order to capture the fan message. Preferably, the fan message will be limited to a particular time limit such as for example 10 seconds in length, 15 seconds in length 25 seconds in length or 30 seconds in length. Although the fan message will normally be limited, a 30 second length limit is preferred. Activation of the shutter button again will typically pause and preferably stop the recording.

At this stage, the fan may be able to review the fan message that has been captured and can choose to either trash the fan message and record another or send/submit the fan message. Once the fan has chosen to send/submit the fan message, the secondary software application operating on the personal computing device will typically forward the fan message to the primary software application operating on the computer server or computer network via the available data transmission pathways. If required, the message can be compressed in size prior to sending and then decompressed by the primary software application.

Once the primary software application operating on the computer server or computer network receives the fan message, the fan message is then preferably forwarded to the influencer. There may be a vetting stage applied to the fan message to ensure that inappropriate fan messages are not forwarded to the influencer. This vetting stage may be accomplished automatically by a part of the primary software application using image recognition software to identify inappropriate images and/or voice or word recognition used to recognize inappropriate audio.

When a fan has already set up their profile and logs into the system at subsequent times, the fan will normally be presented with a homepage interface. The homepage interface will typically include an operations bar or buttons, normally at an upper or lower portion and the operations bar will normally include a home button, search button, a record button, access to the storage facility having the stored messages and replies and a profile button allowing the fan to edit their profile. A generic homepage will also typically include action buttons allowing the fan to ask a question or create a fan message and/or answer a question or fan message.

A similar process to that described above will typically be followed when an influencer logs into the system for the first time. As an influencer using the system, the influencer will typically open the secondary software application operating on their personal computing device by tapping the application icon or tile. The first time an influencer uses the application, the influencer will normally be presented with a signup interface generated and displayed on the display of the personal computing device. The signup interface will prompt the creation of an influencer profile including entry of salient information such as the influencer's name, email address, preferred password and a picture or image to be used as the profile image.

The influencer profile may include other information such as gender, date of birth, address, preferences and/or interests although this information is optional and may be added at a later time into the influencer profile. The influencer profile is preferably stored in a user profile in association with the primary software application operating on the computer server or computer network. The system administrator may undertake a vetting process when an influencer creates a new profile or updates their profile to ensure that the information added into the profile is not scandalous or contrary to law in any way and/or that the information added complies with the information required by the system.

Entry of information into the secondary software application is preferably using a virtual keyboard which is produced and displayed on the interface, normally as an overlay and/or uploaded using the personal computing device, particularly, using the image capture software present on the personal computing device and/or the audio capture software. The information will normally be entered into one or more entry fields provided on the interface and there will normally be one or more action buttons on the interface to allow entry of information and/or movement about the interface.

Once the influencer has set up their user profile, there will normally be an action button allowing them to continue. The influencer can manually activate the “continue” action button and activation of this button will normally trigger generation and display of a further interface.

Influencers will preferably have the ability to set a topic for discussion and edit that topic as required in order to prompt or maintain the interest of fans. The influencer may be incentivized in order to maintain the interest of fans and be rewarded or incentivized according to the number of fans requesting interaction with the influencer.

Importantly, the influencer will be able to view fan messages and answer fan messages with an appropriate action button provided on an interface generated and displayed on the influencer personal computing device. The influencer will typically be given any indication of the number of pending fan messages that are awaiting an answer, normally on a home screen interface. Such an interface may also include a recent activity portion which includes or identifies information relating to the influencer's recent activity. Where more than one entry occurs on the recent activity portion, the recent activity portion may be movable to advance through the recent activity posts. Normally, this is achieved by sliding or swiping the recent activity portion.

When the influencer selects the action button allowing the influencer to answer a fan message, the new interface is typically generated and displayed on the personal computing device of the influencer and at the same time, the audio and visual capture devices of the personal computing device are preferably activated so that the influencer can see a real-time image of themselves on the display of their personal computing device and also a preview portion showing previews of the unanswered fan messages.

Normally, the preview portion includes at least a screenshot “still” from the fan message or the fan's profile picture. The influencer can move through the pending fan messages by direct manipulation on the display of the personal computing device such as by swiping or sliding for example. Selection of a particular fan message to be answered by the influencer will preferably cause the secondary software application operating on the influencer personal computing device to start capture of video and/or audio as the fan message plays in order to capture the reaction recording in real time. The selection may occur in any way using any motion on the display to initiate the selection and the capture of the reaction recording.

Preferably, the fan message will preferably display in a different portion of the interface to the influencer image so that the influencer can see the fan message being played as well is having the influencer image captured and played back to the influencer in real time. Preferably, it will be possible for the influencer to pause the play of the fan message and/or stop the play of the fan message. However, in order to capture the most realistic reaction recording, it is preferred that once the fan message has been initiated, the influencer cannot pause or stop the fan message until the end of the fan message.

Once the fan message has ended, and the reaction recording has taken place, the influencer can then record a response to the fan message. This is typically done through a similar process as the fan recording a fan message as explained above. Once the influencer has recorded their response, the influencer can typically review the response and either dump or trash the response or send/submit the response.

Once sent or submitted, the influencer response will be conveyed to the primary software application operating on the computer network or computer server. The primary software application will then composite the recordings, namely the fan message, the reaction recording and the influencer response into a single composite message. It is important to realize at this juncture that the reaction recording and the influencer response may be substantially continuously recorded and therefore, although there may be two portions to the message, such a combined or continuously recorded message may be a single message and may be combined with the fan message to form a composite message. The composite message is then normally sent back to at least the fan. The composite message may be also loaded onto the influencer profile and will typically be stored against both the influencer profile and the fan profile.

The fan and/or the influencer can also share the composite message with third parties. Preferably, a still shot of the composite message (order still shot of a portion of the message) may be provided as a part of the sharing of the composite message. Text can preferably be added by either the fan and/or the influencer to the sharing of the composite message. Normally, an interface will be generated and displayed on the personal computing device of either the fan and/or the influencer allowing the sharing and this interface may provide the ability for the fan and/or the influencer to nominate the mechanism of sharing, for example by designation of social media networks and the like.

The composite message will typically play the fan message and the influencer reaction response at substantially the same time but preferably slightly delay the influencer reaction response message in order to simulate a short reaction time between the fan message in the influencer reaction response. This will typically elevate the realism provided by the system of the present invention. Once the fan message and influencer reaction response have finished, the influencer response will typically play.

There may be scope to capture a fan reaction response upon reviewing the influencer response to the original fan message and this will typically operate similarly to the system described above.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic view of a preferred embodiment of the hardware portion of the system of the present invention.

FIG. 2 shows a schematic view of the overall operation of a preferred embodiment of the system of the present invention in forming the composite message.

FIG. 3 is an elevation view of a display of a personal computing device used according to a preferred embodiment of the present invention.

FIG. 4 is an illustration of a fan signup interface according to a preferred embodiment of the present invention.

FIG. 5 is an illustration of an influencer selection interface according to a preferred embodiment of the present invention.

FIG. 6 is an illustration of a fan message recording interface according to a preferred embodiment of the present invention.

FIG. 7 is an illustration of an influencer profile interface according to a preferred embodiment of the present invention.

FIG. 8 is an illustration of an influencer homepage interface according to a preferred embodiment of the present invention.

FIG. 9 is an illustration of a review and answer interface according to a preferred embodiment of the present invention.

FIG. 10 is an illustration of a reaction response capture interface according to a preferred embodiment of the present invention.

FIG. 11 is an illustration of an influencer response message capture interface according to a preferred embodiment of the present invention.

FIG. 12 is an illustration of a composite message interface according to a preferred embodiment of the present invention.

FIG. 13 is an illustration of a share interface according to a preferred embodiment of the present invention.

The patent or application file contains at least one drawing executed in color. Copies of this patent or patent application with color drawings will be provided by the Office upon request and payment of the necessary fee.

### DETAILED DESCRIPTION

According to a particularly preferred embodiment of the present invention, a system for compositing asynchronous video messages and responses is provided.

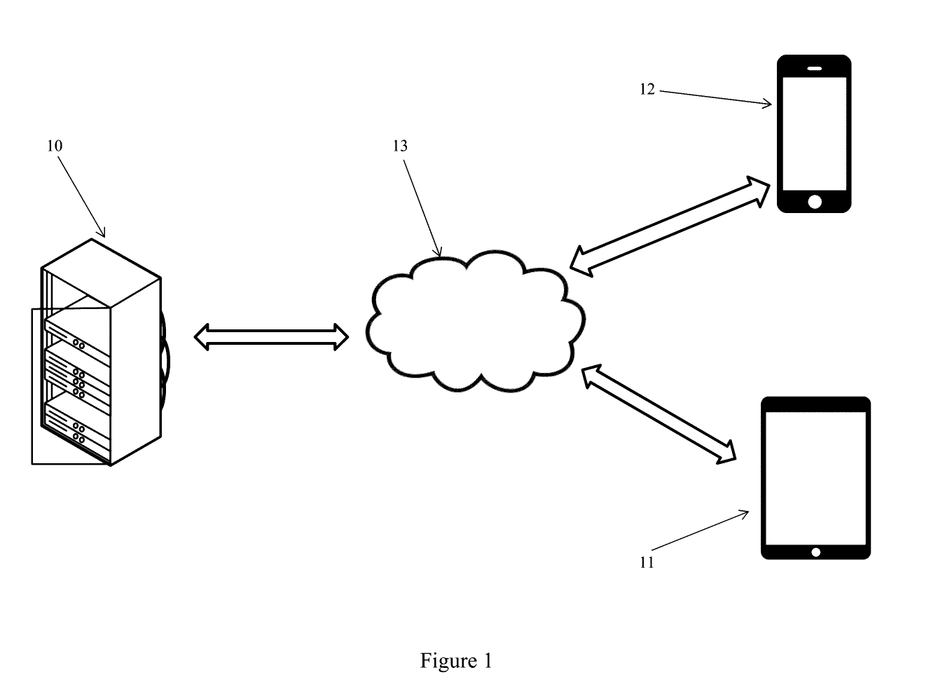

The general hardware implementing the system of the preferred embodiment is illustrated in FIG. 1. As illustrated, the system of the preferred embodiment operates using a computer server 10 which interacts with and transfers information to and receive information from the number of personal computing devices of which two types are illustrated, namely a tablet device 11 and a smartphone 12, through a cloud network 13. Information can be transferred to and from the computer server 10 and the personal computing devices 11, 12 in order to implement the system of the preferred embodiment.

The system of the preferred embodiment includes a computer server 10 operating a primary software application, at least one first person with a personal computing device having an audio capture device, a video capture device and data transmission capability and operating a secondary software application to create an electronic first person message having an audio component and a video component, the at least one first person forwarding the first person message to a second person over an electronic data transmission network 13 accessible through at least the secondary software application operating on the at least one first person's personal computing device, at least one second person with a personal computing device having an audio display and capture device, a video display and capture device and data transmission capability and operating a secondary software application to allow the at least one second person to initiate playback of the first person message on the second person's personal computing device at a time convenient to the second person, capturing a second person reaction recording in real time via the secondary software application, audio display and capture device and video display and capture device of the second person's personal computing device, based on initiating the playback of the first person message, the second person creating a second person response message having an audio component and a visual component in response to the first person message using the secondary software application, the audio display and capture device and video display and capture device of the second person's personal computing device, transmitting the electronic first person message, the second person reaction recording and the second person response message to the primary software application operating on the at least one computer server or computer network, the primary software application operating on the computer server compositing the first person message, the second person reaction recording and the second person response into a composite recording; and delivering the composite recording to at least the first person via an electronic data transmission network 13.

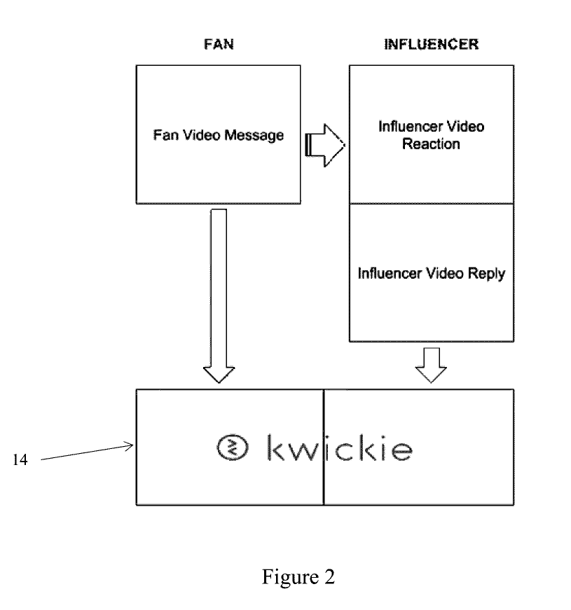

The preferred embodiment of the present invention is system for compositing asynchronous video messages and responses which are best explained conceptually with reference to FIG. 2. The present invention provides a method and system for the recording of separate asynchronous video messages and compositing them into one video, which simulates a real-time, synchronous conversation. In a most preferred embodiment, the method and system of the present invention will be used to allow a fan to interact with an influencer.

The method and system of the present invention is based about a fan utilizing a personal computing device such as a smartphone 12, or tablet computer 11 to capture an audio/video message and then send that audio/video message to an influencer who also has a personal computing device such as a smartphone 12, or tablet computer 11 for playback, record the influencer's reaction to the fan's message, allow the influencer to record an audio/video message in response thereto and then composite the messages and reaction recording into a single composite message 14.

Preferably, access to the system for both the fan and the influencer will be via a respective personal computing device. The secondary software application operating on both the fan and the influencer personal computing devices is preferably the same software application and the functionality and use of the software application determined by the category of the user which is preferably determined at login according to the user's unique login information. The personal computing device can be any type however, it will typically be a smart phone or computer tablet having at least one communication pathway in order to communicate with the computer server 10 operating the primary software application.

The personal computing device preferred for use in the present invention includes a processor with on-board memory, a display, at least one input apparatus, at least one output apparatus (such as audio output, directly via speakers or similar or indirectly via a port or similar allowing the connection of speakers, visual output or similar), and access to at least one communication pathway to transmit data between system components. Normally, the display will preferably be a touchscreen as many personal computing devices currently available have this feature. The advantages of the touchscreen include allowing a larger display and also allowing the display to function as a part of or as, the input apparatus. The display will also function as a video playback device. These types of devices also usually have at least one camera and at least one microphone which will allow video capture and audio capture.

Preferably, the software operating on the hardware of the preferred embodiment includes a primary software application operating on the computer server 10 and a secondary software component is provided at the personal computing device level on each of the user personal computing devices in order to interact with the primary software application.

The primary software application is preferably the “engine” of the system and method, responsible for receiving the various messages and recordings created or captured by a user (fan and/or influencer) and to composite these into a single message for delivery to a user.

Preferably, the secondary software application is provided to operate on a smartphone 12 or tablet 11 with appropriate connections through the smartphone 12 or tablet 11 to the computer server 10 operating a primary software application in order to gain additional information to that present on the smartphone 12 or tablet 11. The additional information may be obtained from the computer server 10 and/or by push notification from the computer server 10 to the smartphone 12 or tablet 11 and/or upon request from the smartphone 12 or tablet 11.

The secondary software application will preferably allow communication with the primary software application operating on the computer server 10. Preferably, the primary software program operating on the computer server 10 is more advanced and is responsible for the bulk of the processing with the secondary software application operating on the smartphone 12 or tablet 11 typically smaller and with less processing power, optimized to send and receive instructions and requests and leaves the operations requiring larger processing power to the primary software program operating on the computer server 10.

Users will normally download the secondary software application to their smartphone 12 or tablet 11. The download of the software application will normally include appropriate instructions to be stored in the memory of the smartphone 12 or tablet 11 in order to create and maintain links and associations with the computer server 10 in order to communicate with one or more databases stored thereon.

The smartphone 12 or tablet 11 normally provides access to one or more communications pathways in order to communicate with the computer server 10 in order to access the system. Normally, the computer server 10 will include or have access to one or more databases containing information about the users such that information regarding the identity of any one or more of these parties may be communicated by the smartphone 12 or tablet 11 or the software application to ensure that the smartphone 12 or tablet 11 requesting data from the computer server 10 or to which data is to be sent or from which information is received, is a smartphone 12 or tablet 11 of an authorized user of the system. This functionality is normally accomplished through a login facility in which the user uses a smartphone 12 or tablet 11 to log into the system.

The login process may use login details that the user has developed for another application or use. For example, the user may use a Facebook or Twitter account login or similar or alternatively login details for an email system such as Gmail or Hotmail in order to access the system of the present invention. Normally, details of the user login will be stored in a corresponding user profile in at least one user database and as a login request is received, the computer server or computer network will typically ensure that the login details supplied match those of a user before allowing access to the system and any databases on the system.

Normally, a login prompt is produced and displayed as a displayed image or interface on the display of the personal computing device and including at least one action button. This will normally allow input or selection of the desired login information into an input template and which also prompts input of the login information provided by action in the form of a submission to the computer server or computer network. This will normally be a two-part process in which the user will normally select the desired login type if permitted followed by entry of the user particular identification information and password followed by the submission step. Upon submission, the entered details will be sent to the primary software application operating on the computer server 10 for authorization.

Therefore, the smartphone 12 or tablet 11 is typically used to create a login request which is then sent via a communications pathway to the computer server 10 whereupon the system of the present invention checks the user database(s) for a match and allows access to the system if the match occurs and denies access to the system if a match does not occur.

An input apparatus used to input information into the smartphone 12 or tablet 11 therefore will typically be formed or displayed on the display of the personal computing device as required, normally in the form of a virtual keyboard including letters of the alphabet, numbers and/or symbols as well as one or more action icons to allow a user to implement action on the smartphone 12 or tablet 11.

The method of the present invention is preferably achieved by computer hardware operating software containing instructions in association with one or more communications pathways between the computer hardware operating software compliant with the system, in order to achieve the method.

The computer server or computer network will normally include a processor with memory operating instructions and a number of databases stored in electronic form. The databases will typically include at least one user database containing a unique user profile for each user of the system and at least one database of messages and/or recordings may be maintained separately from the at least one user database or alternatively, the messages and/or recordings may be stored in the respective user profiles. It is anticipated that the at least one user database can be provided as a single database, with the designation of a user as being either a fan or influencer (or both) dependent upon the use of the system.

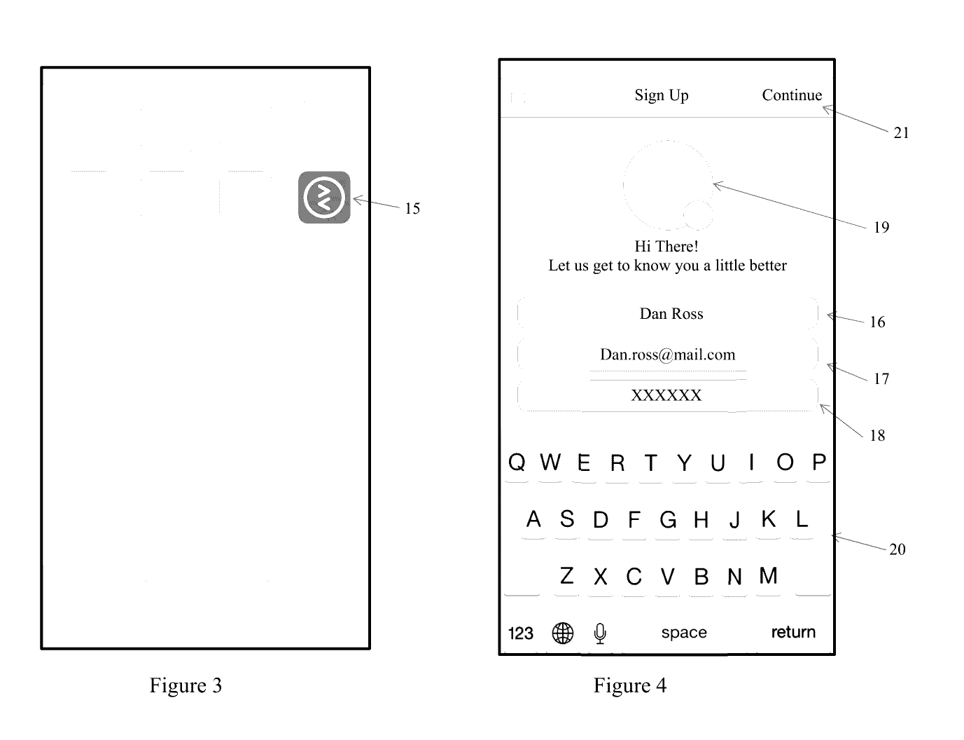

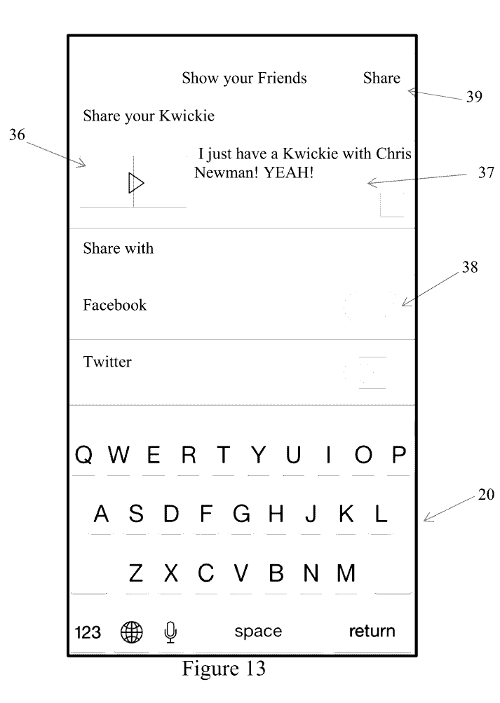

The system of the present invention will normally be implemented through instructions which when followed, generate one or more interfaces on a smartphone 12 or tablet 11, and examples of these interfaces are included as FIGS. 3 to 13. The instructions will normally be sent from the primary software application on the computer server 10 to a user's smartphone 12 or tablet 11 and which will then be followed in order to generate an interface in real time and update the interface according to the user's interaction with the system.

Many smartphones 12 or tablets 11 have touchscreens for display allowing the user to directly interact with the touch screen in order to interact with the interface. One or more “buttons” are provided on the interface to allow the user to interact with the smartphone 12 or tablet 11 and through the smartphone 12 or tablet 11, to interact with the system.

The generated interface will typically be updated substantially in real time according to the rules or instructions which are issued by the primary software application operating on the computer server 10 and the at least one user database. The generated interface will also typically be updated substantially in real time according to interactions by the user(s) with the system.

Typically, the generated interface will be used to login to the system using unique login information or details. Normally this will be the case regardless of what type of user is logging into the system. The classification of the user as a fan or influencer may be made according to the login details or by the user, after login. The system will preferably allow a user to set up a profile designating themselves as a fan, influencer or both and this setup (or any change thereto) is preferably subject to approval by the system administrator.

As mentioned above, a user may login to a third-party system such as a social media network and then access the system of the present invention by interacting or selecting a link which may be displayed on the social media network site. For example, one particularly preferred mechanism for entry to the system of the present invention is through Facebook and particularly, through a link or share which appears on a user's newsfeed. The link will typically be associated with explanatory text or material which explains the concept of the system and because the user is interested, the user will normally, having already logged into Facebook, simply select the link and be redirected to the generated interface of the system of the present invention.

Upon logging by a user, the system of the present invention will preferably generate and display an interface on the smartphone 12 or tablet 11 according to the user category as either a fan or an influencer. A user who is a member of both categories may be prompted to choose their next action.

As a fan using the system, the fan will typically open the secondary software application operating on their personal computing device by tapping the application icon or tile 15 as illustrated in FIG. 3. The first time a fan uses the application, the fan will normally be presented with a signup interface generated and displayed on the display of the smartphone 12 or tablet 11 such as that illustrated in FIG. 4. The signup interface will prompt the creation of a fan profile including entry of salient information such as the fan's name 16, email address 17, preferred password 18 and a picture or image to be used as the profile image 19.

The fan profile may include other information such as gender, date of birth, address, preferences and/or interests although this information is optional and may be added at a later time into the fan profile. The fan profile is preferably stored in a user profile in association with the primary software application operating on the computer server 10. The system administrator may undertake a vetting process when a fan creates a new profile or updates their profile to ensure that the information added into the profile is not scandalous or contrary to law in any way and/or that the information added complies with the information required by the system.

Entry of information into the secondary software application is preferably using a virtual keyboard 20 which is produced and displayed on the interface, normally as an overlay, but information such as an image can be uploaded using the smartphone 12 or tablet 11, particularly, using the image capture software present on the smartphone 12 or tablet 11 and/or the audio capture software. The information will normally be entered into one or more entry fields provided on the interface as illustrated in FIG. 4 and there will normally be one or more action buttons on the interface to allow entry of information and/or movement about the interface.

Once the fan has set up their user profile, there will normally be an action button allowing them to continue. The fan can manually activate the “continue” action button 21 and activation of this button will normally trigger generation and display of a further interface.

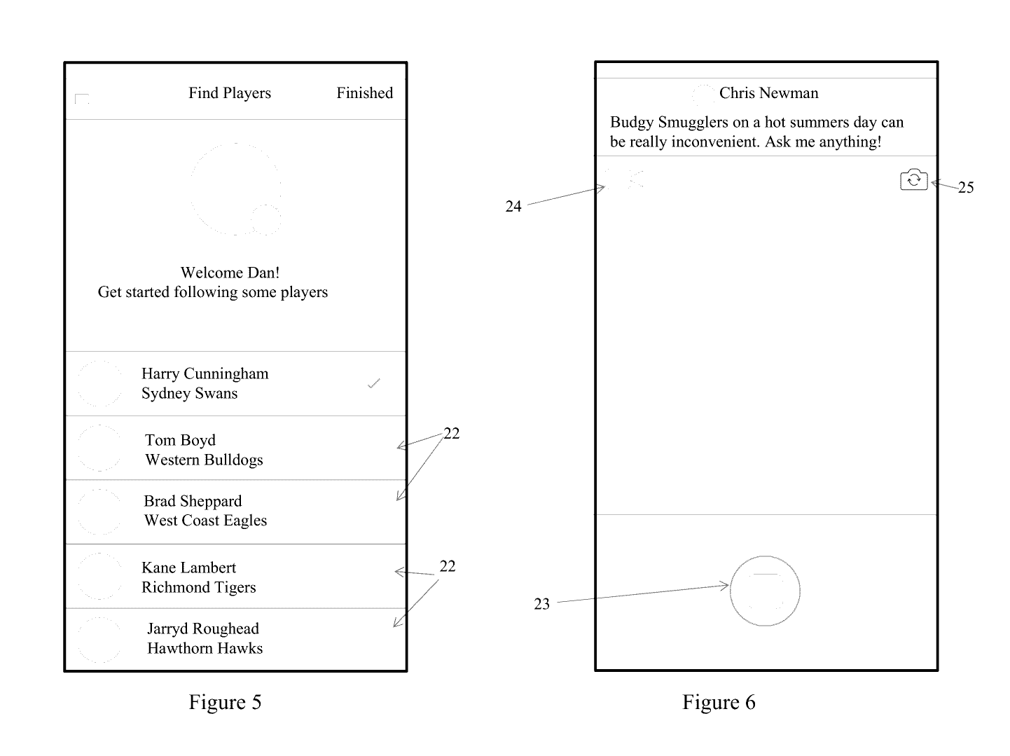

The further interface generated and displayed will typically depend upon whether this is the fan's first use of the system or a later use. If it is the fan's first use the fan may be prompted to indicate one or more influencers that the fan would like to follow. This is preferably performed through the generation and display of an interface allowing a fan to select one or more influencers from a list as illustrated in FIG. 5. This can be done in any way. For example, the system may have a search facility allowing a fan to search for an influencer's name such as by entry of text, by category, by sporting team or using any other parameter that could be used to identify and characterize an influencer. There may be the ability to provide an influencer leaderboard of most popular influencers and/or suggested influencers based on preferences entered by the fan.

Once the fan has identified one or more influencers to follow, the fan can then preferably “follow” the influencer by tapping an action button 22 which will trigger the addition of that influencer to the fan's profile. Normally, after the setup stage, every time the fan logs into the system, the fan can select from a stored list of influencers that they are following in order to undertake further action.

The fan will also preferably have an action button provided on either the influencer profile interface or directly from the influencer selection interface that will allow the fan to create a fan message. Typically, the action button will allow the fan to begin recording a fan message. The action button will typically be known as a shutter button 23 in some preferred embodiments. Other setup buttons may be provided on the interface or on a subsequent interface allowing the fan to set up the recording. The fan will typically be allowed to designate that video is recorded 24 or a still image is recorded together with audio and also be provided with a flip camera button 25 to activate either the front or rear camera on the smartphone 12 or tablet 11 as required.

Activation of the shutter button 23 by the fan causes the secondary software application operating on the personal computing device to begin recording audio and preferably video via the hardware provided on the smartphone 12 or tablet 11 in order to capture the fan message. Preferably, the fan message will be limited to a particular time limit such as for example 10 seconds in length, 15 seconds in length 25 seconds in length or 30 seconds in length. Activation of the shutter button 23 again will typically stop the recording.

At this stage, the fan may be able to review the fan message that has been captured and can choose to either trash the fan message and record another or send/submit the fan message. Once the fan has chosen to send/submit the fan message, the secondary software application operating on the personal computing device will typically forward the fan message to the primary software application operating on the computer server or computer network via the available data transmission pathways. If required, the message can be compressed in size prior to sending and then decompressed by the primary software application.

Once the primary software application operating on the computer server or computer network receives the fan message, the fan message is then preferably forwarded to the influencer. There may be a vetting stage applied to the fan message to ensure that inappropriate fan messages are not forwarded to the influencer. This vetting stage may be accomplished automatically by a part of the primary software application using image recognition software to identify inappropriate images and/or voice or word recognition used to recognize inappropriate audio.

When a fan has already set up their profile and logs into the system at subsequent times, the fan will normally be presented with a homepage interface. The homepage interface will typically include an operations bar 26 with buttons, normally at an upper or lower portion and the operations bar will normally include (from left to right in FIG. 8) a home button, search button, a record button, access to email storage facility having the stored messages and replies and a profile button allowing the fan to edit their profile. A generic homepage such as that illustrated in page 8 will also typically include an action button 27 allowing the fan to ask a question or create a fan message and/or an action button 28 allowing the fan to answer a question or fan message.

A similar process to that described above will typically be followed when an influencer logs into the system for the first time. As an influencer using the system, the influencer will typically open the secondary software application operating on their personal computing device by tapping the application icon or tile. The first time an influencer uses the application, the influencer will normally be presented with a signup interface generated and displayed on the display of the personal computing device. The signup interface will prompt the creation of an influencer profile including entry of salient information such as the influencer's name, email address, preferred password and a picture or image to be used as the profile image.

The influencer profile may include other information such as gender, date of birth, address, preferences and/or interests although this information is optional and may be added at a later time into the influencer profile. The influencer profile is preferably stored in a user profile in association with the primary software application operating on the computer server or computer network. The system administrator may undertake a vetting process when an influencer creates a new profile or updates their profile to ensure that the information added into the profile is not scandalous or contrary to law in any way and/or that the information added complies with the information required by the system.

Entry of information into the secondary software application is preferably using a virtual keyboard which is produced and displayed on the interface, normally as an overlay and/or uploaded using the personal computing device, particularly, using the image capture software present on the personal computing device and/or the audio capture software. The information will normally be entered into one or more entry fields provided on the interface and there will normally be one or more action buttons on the interface to allow entry of information and/or movement about the interface.

Once the influencer has set up their user profile, there will normally be an action button allowing them to continue. The influencer can manually activate the “continue” action button and activation of this button will normally trigger generation and display of a further interface.

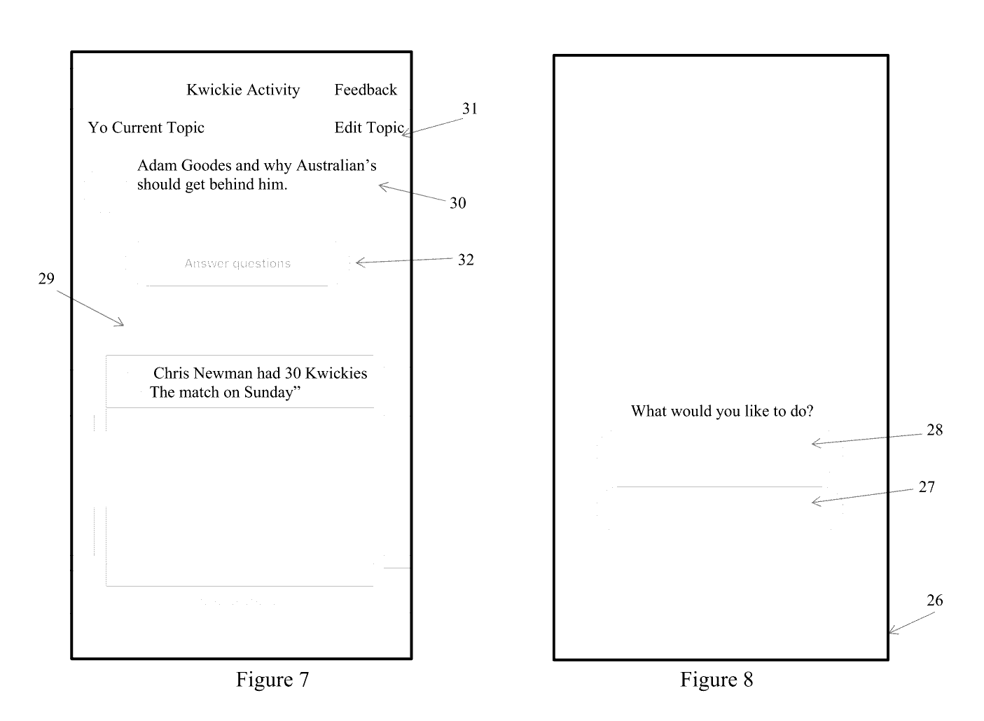

As illustrated in FIG. 7, influencers will preferably have the ability to set a topic for discussion 30 and edit 31 that topic as required in order to prompt or maintain the interest of fans. The influencer may be incentivized in order to maintain the interest of fans and be rewarded or incentivized according to the number of fans requesting interaction with the influencer.

Importantly, the influencer will be able to view fan messages and answer fan messages with an appropriate action button provided on an interface generated and displayed on the influencer personal computing device, similar to the interface illustrated in FIG. 8. The influencer will typically be given any indication of the number of pending fan messages that are awaiting an answer, normally on a home screen interface. As shown in FIG. 7, such an interface may also include a recent activity portion 29 which includes or identifies information relating to the influencer's recent activity. Where more than one entry occurs on the recent activity portion, the recent activity portion may be movable to advance through the recent activity posts. Normally, this is achieved by sliding or swiping the recent activity portion 29 preferably sideways.

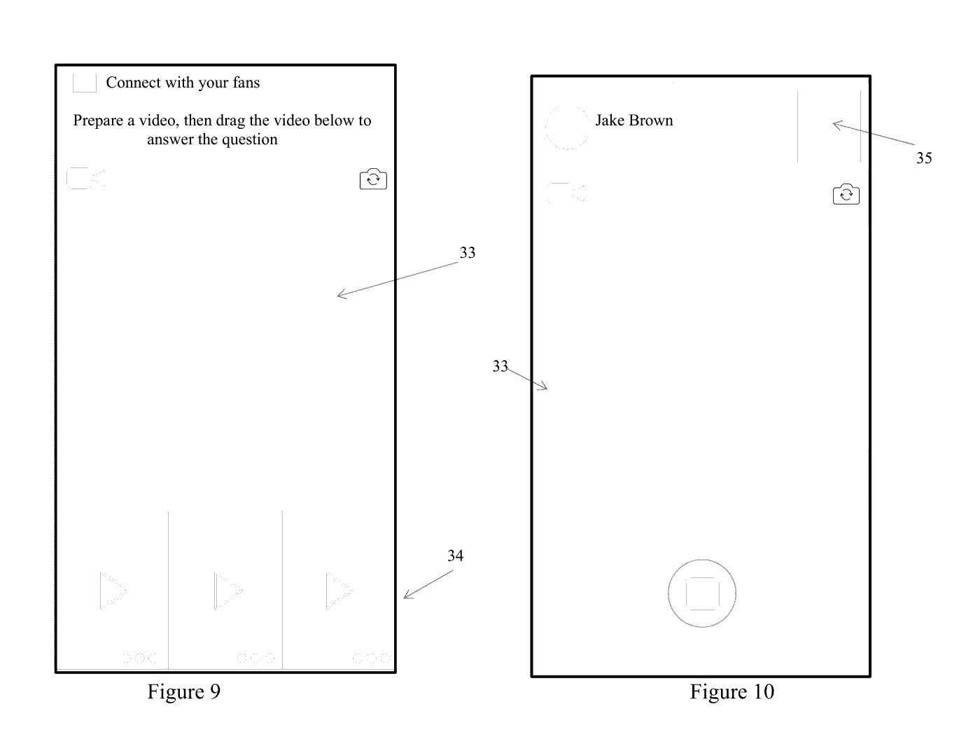

When the influencer selects the action button 32 allowing the influencer to answer a fan message, the new interface is typically generated and displayed on the smartphone 12 or tablet 11 of the influencer and at the same time, the audio and visual capture devices of the smartphone 12 or tablet 11 are preferably activated so that the influencer can see a real-time image of themselves 33 on the display of their smartphone 12 or tablet 11 and also a preview portion 34 showing previews of the unanswered fan messages. An example of this interface is illustrated in FIG. 9.

As illustrated in FIG. 9, the preview portion of the preferred embodiment includes at least a screenshot “still” from the fan message or the fan's profile picture. The influencer can move through the pending fan messages by direct manipulation on the display of the personal computing device such as by swiping or sliding for example. Selection of a particular fan message to be answered by the influencer will preferably cause the secondary software application operating on the influencer personal computing device to start capture of video and/or audio as the fan message plays in order to capture the reaction recording in real time. The selection may occur in any way using any motion on the display to initiate the selection and the capture of the reaction recording.

As illustrated in FIG. 10, during the playing of the fan message, the fan message will preferably display in a different portion 35 of the interface to the influencer image 33 so that the influencer can see the fan message being played as well as having the influencer image captured and played back to the influencer in real time. Preferably, it will be possible for the influencer to pause the play of the fan message and/or stop the play of the fan message. However, in order to capture the most realistic reaction recording, it is preferred that once the fan message has been initiated, the influencer cannot pause or stop the fan message until the end of the fan message.

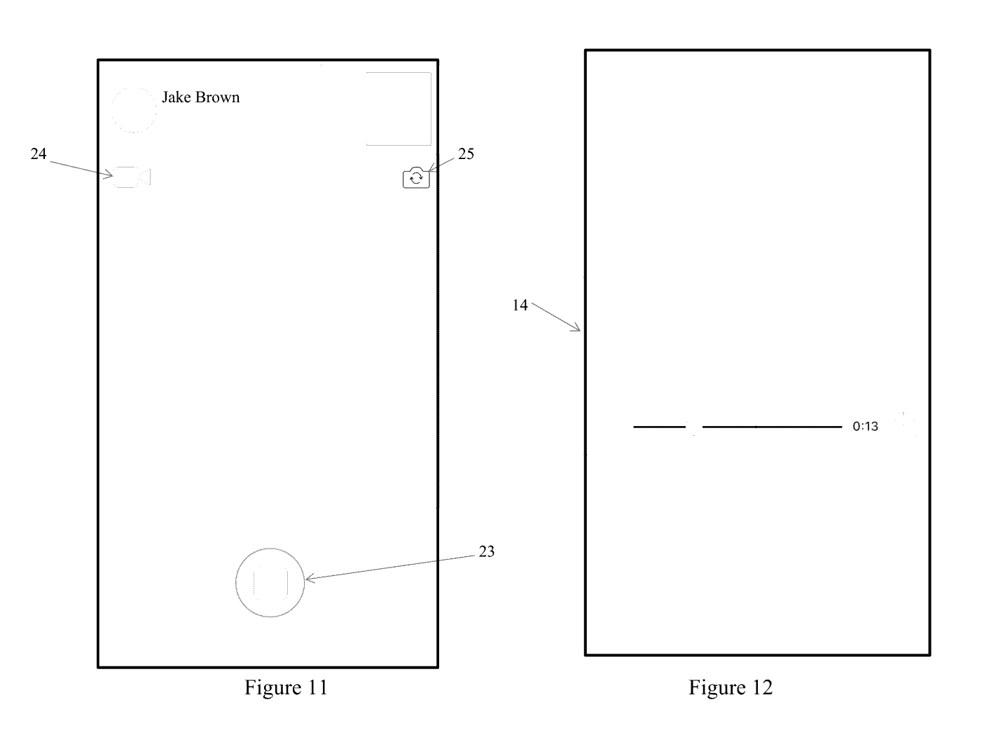

Once the fan message has ended, and the reaction recording has taken place, the influencer can then record a response to the fan message utilizing an interface such as that illustrated in FIG. 11. This is typically done through a similar process as the fan recording a fan message as explained above. Once the influencer has recorded their response, the influencer can typically review the response and either dump or trash the response or send/submit the response.

Once sent or submitted, the influencer response will be conveyed to the primary software application operating on the computer network or computer server. The primary software application will then composite the recordings, namely the fan message, the reaction recording and the influencer response into a single composite message according to the schematic illustrated in FIG. 2, to produce a composite message 14, one form of which is illustrated in FIG. 12. It is important to realize at this juncture that the reaction recording and the influencer response may be substantially continuously recorded and therefore, although there may be two portions to the message, such a combined or continuously recorded message may be a single message and may be combined with the fan message to form a composite message 14. The composite message 14 is then normally sent back to at least the fan. The composite message 14 may be also loaded onto the influencer profile and will typically be stored against both the influencer profile and the fan profile.

The fan and/or the influencer can also share the composite message 14 with third parties. Preferably, a still shot of the composite message 36 (or a still shot of a portion of the message) may be provided as a part of the sharing of the composite message. Text 37 can preferably be added by either the fan and/or the influencer to the sharing of the composite message using the virtual keyboard 20. Normally, an interface will be generated and displayed on the smartphone 12 or tablet 11 of either the fan and/or the influencer allowing the sharing and this interface may provide the ability for the fan and/or the influencer to nominate the mechanism of sharing, for example by designation of social media networks 38 and the like. This interface includes a “share” action button 39.

The composite message will typically play the fan message and the influencer reaction response at substantially the same time but preferably slightly delay the influencer reaction response message in order to simulate a short reaction time between the fan message and the influencer reaction response. This will typically elevate the realism provided by the system of the present invention. Once the fan message and influencer reaction response have finished, the influencer response will typically play.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A system for compositing asynchronous video messages and responses comprising:
a. at least one computer server or computer network operating a primary software application maintained by a system administrator;
b. receiving at the at least one computer server or computer network, an electronic first person message having an audio component and a video component created by at least one first person using a personal computing device having an audio capture device, a video capture device and data transmission capability and operating a secondary software application;
c. forwarding the first person message to a second person over an electronic data transmission network accessible through at least the secondary software application operating on the at least one first person's personal computing device via the at least one computer server or computer network operating a primary software application;
d. receiving at the at least one computer server or computer network, a second person reaction recording created in real time via a personal computing device having an audio display and capture device, a video display and capture device and data transmission capability and operating a secondary software application, based on initiating playback of the first person message;
e. receiving at the at least one computer server or computer network a second person response message having an audio component and a visual component in response to the first person message created using the secondary software application, the audio display and capture device and video display and capture device of the second person's personal computing device;
f. compositing at the at least one computer server or computer network, the first person message, the second person reaction recording and the second person response into a composite recording; and
g. delivering via the at least one computer server or computer network, the composite recording to at least the first person via an electronic data transmission network.

2. The system according to claim 1 wherein, access to the system for both the first person and the second person will be via the respective personal computing device communicating with the at least one computer server or computer network operating a primary software application.

3. The system according to claim 1 wherein, the primary software application is responsible for receiving the electronic first person message, the second person reaction recording and the second person response message to composite these into a single message for delivery to a user.

4. The system according to claim 1 wherein, the computer server or computer network is associated with at least one user database containing a unique user profile for each user of the system with the messages and recordings relating to a user stored in the respective user profile.

5. The system according to claim 1 wherein, the computer server or computer network issues instructions via the primary software application which when followed, generate one or more interfaces on the personal computing device of the first person and the second person.

6. The system according to claim 5 wherein, the instructions are sent from the primary software application on the computer server or computer network to the first person's personal computing device and the second person's personal computing device and which are followed by the secondary software application in order to generate an interface in real time on the personal computing device and update the interface according to the person's interaction with the system.

7. The system according to claim 6 wherein, the generated interface is updated substantially in real time according to the rules or instructions which are issued by the primary software application operating on the computer server or computer network in association with the at least one user database and according to interactions by the person with the system.

8. The system according to claim 1 wherein, the first person's personal computing device has at least one interface generated thereon with an electronic action button provided on either a second person's profile interface or directly from a second person's selection interface that allows the first person to create a first person message.

9. The system according to claim 8 wherein, activation of the electronic action button by the first person causes the secondary software application operating on the personal computing device initializes the audio capture device and video capture device on the personal computing device to begin recording audio and video to record the first person message.

10. The system according to claim 9 wherein the first person can use the secondary software application operating on the personal computing device to send/submit the first person message to the primary software application operating on the computer server or computer network via the data transmission capability of the personal computing device.

11. The system according to claim 10 wherein once the primary software application operating on the computer server or computer network receives the first person message, the first person message is then forwarded to the second person through the secondary software application operating on the personal computing device of the second person.

12. The system according to claim 1 wherein each second person has the ability to set a topic for discussion and edit that topic as required in order to prompt or maintain the interest of the first persons.

13. The system according to claim 1 wherein each second person can view fan messages and answer fan messages with an action button provided on an interface generated and displayed on the second person's personal computing device by the secondary software application upon instructions from the primary software application.

14. The system according to claim 13 wherein when the second person selects the action button allowing the second person to answer a first person message, a new interface is generated and displayed on the personal computing device of the second person and at the same time, the audio capture device and visual capture device of the personal computing device are activated so that the second person can see a real-time image of themselves on the display of their personal computing device and also a portion showing first person messages.

15. The system according to claim 14 wherein, the first person message being answered displays in a different portion of the interface to the second person image so that the second person can see the first person message being played as well as having the second person image captured and played back to the second person in real time.

16. The system according to claim 15 wherein, once the first person message has ended, and the reaction recording has taken place, the second person can then record a response to the first person message by activation of an electronic action button by the second person causing the secondary software application operating on the personal computing device to initialize the audio capture device and video capture device on the personal computing device to begin recording audio and video to record the second person response message.

17. The system according to claim 16 wherein the second person response message is conveyed to the primary software application operating on the computer network or computer server and the primary software application creates the first person message, the reaction recording and the second person response message into a single electronic composite message.

18. A method of compositing asynchronous video messages and responses including the steps of:
a. first person creating an electronic first person message having an audio component and a visual component;
b. forwarding the first person message to a second person over an electronic data transmission network;
c. the second person initiating playback of the first person message at a time convenient to the second person;
d. capturing a second person reaction recording in real time based on initiating the playback of the first person message;
e. the second person creating a second person response message having an audio component and a visual component in response to the first person message;
f. compositing the first person message, the second person reaction recording and the second person response into a composite recording; and
g. delivering the composite recording to at least the first person via an electronic data transmission network.

19. A system for compositing asynchronous video messages and responses, the system including:
a. at least one computer server or computer network operating a primary software application;
b. at least one first person with a personal computing device having an audio capture device, a video capture device and data transmission capability and operating a secondary software application to create an electronic first person message having an audio component and a video component;
c. the at least one first person forwarding the first person message to a second person over an electronic data transmission network accessible through at least the secondary software application operating on the at least one first person's personal computing device;
d. at least one second person with a personal computing device having an audio display and capture device, a video display and capture device and data transmission capability and operating a secondary software application to allow the at least one second person to initiate playback of the first person message on the second person's personal computing device at a time convenient to the second person;
e. capturing a second person reaction recording in real time via the secondary software application, audio display and capture device and video display and capture device of the second person's personal computing device, based on initiating the playback of the first person message;
f. the second person creating an second person response message having an audio component and a visual component in response to the first person message using the secondary software application, the audio display and capture device and video display and capture device of the second person's personal computing device;
g. transmitting the electronic first person message, the second person reaction recording and the second person response message to the primary software application operating on the at least one computer server or computer network;
h. the primary software application operating on the at least one computer server or computer network compositing the first person message, the second person reaction recording and the second person response into a composite recording; and
i. delivering the composite recording to at least the first person via an electronic data transmission network.
